(19) United States
(12) Patent Application Publication
(10) Pub. No.: US 2016/0163230 A1
(43) Pub. Date: Jun. 9, 2016

(54) DEVICE OF BRAILLE INPUT AND OUTPUT

(71) Applicant: HIMS INTERNATIONAL CORPORATION, DAEJEON (KR)

(72) Inventors: YANG TAIK YOON, DAEJEON (KR); KYEONG SEON CHOI, DAEJEON (KR); KIHUN JANG, DAEJEON (KR); HYUN SEOP LIM, DAEJEON (KR); KWANGHEE LEE, CHUNGCHEONGBUK-DO (KR)

(73) Assignee: HIMS INTERNATIONAL CORPORATION, DAEJEON (KR)

(21) Appl. No.: 14/738,435

(22) Filed: Jun. 12, 2015

(30) Foreign Application Priority Data
Dec. 8, 2014 (KR) 10-2014-0174891

(51) Int. Cl. G09B 21/02

(52) U.S. Cl. CPC G09B 21/02

(57) ABSTRACT

The present invention relates to a braille input and output device which recognizes a normal word transmitted from the outside as braille by a tactile sense of a person and converts a braille input through an input key assembly into a normal word to wirely or wirelessly transmit the normal word. According to the present invention, the braille input through the input key assembly is reversely translated into the normal word or the normal word which is transmitted from a wirelessly connected external apparatus is translated into braille so that information which is input as the braille is translated into the normal word to be transmitted to the external apparatus. Further, according to the present invention, a signal which is input as a braille through the input key assembly is converted into a command which performs a predetermined function or an abbreviation obtained by abbreviating a word to be recognized by tactile sense or auditory sense of a user so that a lot of braille information may be embossed on a braille display module which is restrictedly output.

### CROSS-REFERENCE TO RELATED APPLICATIONS

This application claims priority to and the benefit of Korean Patent Application No. 10-2014-0174891 filed in the Korean Intellectual Property Office on 8 Dec. 2014, the entire contents of which are incorporated herein by reference.

### TECHNICAL FIELD

The present invention relates to a device which inputs braille and converts a normal word which is transmitted from an external apparatus into braille to output the braille, and more particularly, to a braille input and output device which recognizes a normal word transmitted to this device from the outside through a tactile sense of a human being and converts a braille input through an input key assembly into a normal word to wirely or wirelessly transmit the normal word to the external apparatus. Here, the normal word literally refers to a letter which is written by ink and is used as a relative concept with respect to the braille. In the specification, it is understood that the normal word is a letter or an image which is used by a normal person (a person having normal vision) without having visual handicap.

### BACKGROUND ART

Braille which is mainly used by a person who is visually impaired is formed of six dots of 3 by 2 or eight dots of 4 by 2. The braille was generally used for a braille book in the past. In the meantime, in accordance with recent development of electronic technology, as means for representing a text, not only a book, but also a screen of an electronic apparatus is used these days. In order to input the text in the electronic device, a keyboard or a touch pad is generally used. However, the keyboard which is generally used is manufactured with a specification which is convenient for a normal person who does not have any visual handicap but a person who is visually impaired cannot conveniently use the keyboard.

Korean Unexamined Patent Application Publication No. 10-2008-0086203 (hereinafter, referred to as a “related art”) discloses a keypad to input braille and a braille input and output device which outputs input information as braille. The device according to the related art includes an input unit main body including a braille key input unit which inputs a signal corresponding to braille and an output unit main body including a braille output unit which outputs the signal input through the braille key input unit as braille, and a control unit which controls the braille output unit based on the signal input through the braille key input unit to display braille corresponding to the input signal in real time. According to the related art, the signal input through the braille key input unit is output through the braille output unit, so that the person who is visually impaired can simultaneously input the braille key input unit while checking the input braille.

However, according to the related art, the device is a device which simply displays the braille input through the braille key input unit but does not include a device which translates the normal word received from the outside into braille or reversely translates the input braille into the normal word, so that it is difficult to link the device with an external apparatus, for example, an external terminal, such as a computer or a notebook computer. Further, the device which outputs the braille is configured to output only a small number of braille so that it requires a lot of time for the person who is visually impaired to check for the braille. Further, the related art document provides only a function which transmits the input braille information to the external apparatus but does not have a function which controls the external apparatus, so that it is difficult to utilize the external apparatus. For example, when the person who is visually impaired wants to move a page which is output onto a screen of the external apparatus up/down or left/right, it is difficult to transmit a signal to move the page, so that it is restricted to utilize the function of the external apparatus.

### RELATED ART DOCUMENT

### Patent Document

Patent Document 1: Korean Unexamined Patent Application Publication No. 10-2008-0086203 (titled “Braille Input and Output Device”, published on Sep. 25, 2008).

### SUMMARY OF THE INVENTION

The present invention has been made in an effort to provide a braille input and output device which embosses a braille signal input through an input key assembly to be recognized by a tactile sense and an auditory sense of a user and converts the input braille signal into a normal word signal to transmit the braille signal to a wired or wirelessly connected external apparatus to control the external apparatus like a keyboard and input a letter into the external apparatus.

The present invention has been made in an effort to further provide a braille input and output device which receives a normal word signal from a wirelessly or wirely connected external apparatus to translate the normal word signal into a braille signal or output the normal word signal to a braille output module or output a braille signal received from the external apparatus to the braille output module.

The present invention has been made in an effort to further provide a braille input and output device which performs bidirectional communication to convert the braille signal input through the input key assembly into the normal word signal to transmit the normal word signal to the external apparatus and receive the braille signal or the normal word signal from the external apparatus to emboss the signal onto a braille output module as a braille, that is, simultaneously inputs and outputs the braille.

The present invention has been made in an effort to further provide a braille input and output device which allows a user to recognize information such as a current connection state of the braille input and output device or power information in accordance with a command signal input through an input key assembly by a tactile sense or an auditory sense.

An exemplary embodiment of the present invention provides a braille input and output device, including: an input key assembly which is manipulated by a user; an abbreviation database in which information on abbreviations obtained by abbreviating at least one command which executes predetermined functions or words which is used as languages by a person who is not visually impaired is stored; an input signal recognizing unit which compares the signal input through the input key assembly with at least one command or abbreviations which are stored in the abbreviation database to extract matching information; a control unit which generates and transmits a command signal corresponding to the recognized information as the input signal recognizing unit recognizes the matching information; a braille output module which embosses the function or the abbreviation corresponding to the command signal as braille to be recognized by a tactile sense; and a translating unit which converts the abbreviation into a word which is used by the person who is not visually impaired.

The braille input and output device may further include a communication unit which wirely or wirelessly communicates with the external apparatus.

The translating unit may include a reverse braille translating unit which converts the abbreviation into a word used by the person who is not visually impaired and a braille translating unit which translates the word which is received from the external apparatus or used by another person who is not visually impaired into the abbreviation.

The braille input and output device may further include a voice output unit which outputs information corresponding to the command signal as voice.

The communication unit may further include: a connected apparatus storing unit which stores apparatus information of the connected external apparatus when the device is wirelessly connected with the external apparatus; a wireless communication control unit which receives a command signal to check a connection list from the control unit; and a connection list management unit which extracts a predetermined number of apparatus information stored in the external apparatus storing unit for a predetermined period in accordance with the command signal to check the connection list to transmit the extracted apparatus information to the braille output module.

The wireless communication control unit may further receive a command signal to change the wireless communication mode from the control unit and the communication unit may further include: a connection mode selecting unit which selects any one of a unidirectional mode and a bidirectional mode as a communication mode with the external apparatus in accordance with a command signal to change the wireless communication mode; and a connecting apparatus selecting unit which wirelessly connects a predetermined number of external apparatuses used in a specific mode, selected by the external apparatus selecting unit.

The communication unit may further include a wireless communication unit which transmits a word used by the person who is not visually impaired corresponding to the signal input through the input key assembly to the external apparatus and receives a word or a braille signal which is used by another person who is not visually impaired from the external apparatus when the communication mode is the bidirectional mode. The wireless communication unit may transmit a word used by the person who is not visually impaired corresponding to the signal input through the input key assembly to the external apparatus when the communication mode is a unidirectional mode.

The present invention may emboss a braille signal input through the input key assembly to be recognized by a tactile sense and an auditory sense of a user and convert the input braille signal into a normal word signal to transmit the normal word signal to a wirelessly or wirely connected external apparatus to control the external apparatus like a keyboard and input a letter to the external apparatus, so that a person who is visually impaired may utilize the external apparatus without any restrictions.

Another exemplary embodiment of the present invention is to receive a normal word signal from a wirelessly or wirely connected external apparatus to translate the normal word signal into a braille signal or output the normal word signal to a braille output module or output a braille signal received from the external apparatus to the braille output module, so that a person who is visually impaired may check the normal word information transmitted from the external apparatus through the braille.

Another object of the present invention is to perform bidirectional communication to convert the braille signal input through the input key assembly into the normal word signal to transmit the normal word signal to the external apparatus and receive the braille signal or the normal word signal from the external apparatus to emboss the signal onto a braille output module as braille, that is, simultaneously input and output the braille, thereby transmitting and receiving data with the external apparatus.

According to the present invention, a user recognizes information such as a current connection state of the braille input and output device or power information by tactile sense or auditory sense in accordance with a command signal input through an input key assembly so that the user may check and control a current state of the braille input and output device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating an exemplary embodiment of a braille input and output device according to the present invention.

FIG. 2 is a diagram of a braille input and output device according to the present invention.

FIG. 3 is a diagram illustrating a translating unit according to the present invention.

FIG. 4 is a diagram illustrating a power supply according to the present invention.

FIG. 5 is a diagram illustrating a communication unit according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter, exemplary embodiments of the present invention will be described in detail with reference to the accompanying drawings. In the following description of exemplary embodiments, a detailed explanation of known related functions and constitutions may be omitted so as to avoid unnecessarily obscuring the subject matter of the present invention.

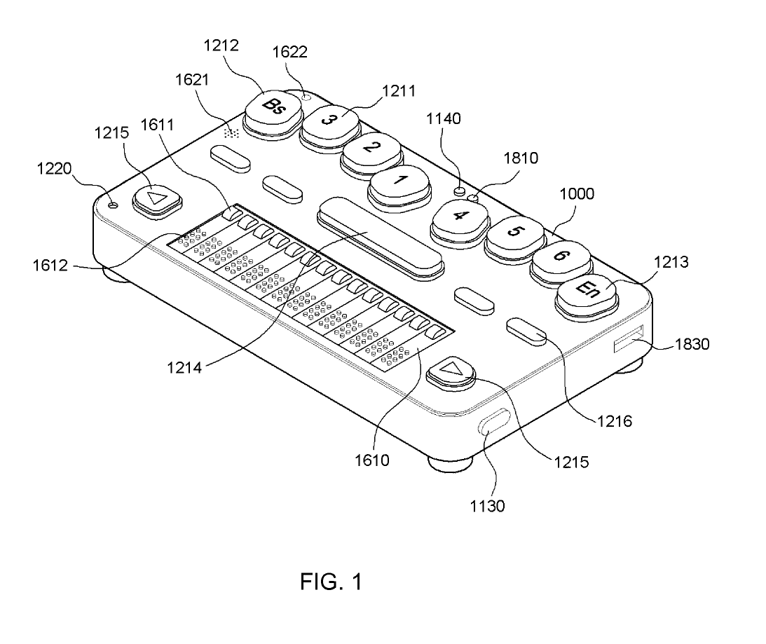

FIG. 1 is an exemplary embodiment of a braille input and output device according to the present invention.

As illustrated in FIG. 1, a braille input and output device 1000 may include a switch 1130 which turns on or off a power supply of the braille input and output device 100 and a power display unit 1140 which is turned on when the power supply is turned on. When the switch 1130 is pressed for a predetermined time, a booting sound is generated and the power display unit 1140 emits green light. Further, when power is applied from the outside, the power display unit 1140 emits red light.

As illustrated in FIG. 1, the braille input and output device 1000 may include a braille input button 1211 which inputs braille formed of six dots, a backspace button 1212 which returns the input braille to a predetermined section, an enter button 1213 which executes a completing command of the input braille, a space button 1214 which inputs a space between braille, a page movement button 1215 which moves a page left or right, and a function button 1216 which moves a menu to a previous item or a next item. The braille input button 1211, the backspace button 1212, the enter button 1213, the space button 1214, the page movement button 1215, and the function button 1216 are included in an input key assembly 1210.

As illustrated in FIG. 1, it is confirmed that there are four function buttons. The four function buttons control the menu to move up/down and left/right. For example, when there is a total of seven main menus, a menu moves by an up key or a down key to be selected. Here, the space button 1214 is used as a key for changing an item in accordance with the selection and the enter button 1213 may be used as a key for storing the changed setting. The menu movement and selection are not limited to the above-described example, but may be modified and designed. Further, referring to FIG. 1, it is understood that a total of 14 braille cells are provided. Here, a braille cell means a unit of one output braille. Therefore, there may be a problem in that the number of output braille is limited to 14. Therefore, when a page movement button 1215 which is provided at a left side is clicked, braille before 14 cells is output and when a page movement button 1216 which is provided at a right side, braille after 14 cells is output. As a result, the total number of braille cells is not limited to 14 as described above.

Referring to FIG. 1, the braille output module 1610 is a device which recognizes the braille by a tactile sense of a user using a signal which is input through the input key assembly 1210 and includes a position selecting unit 1611 and a braille bump 1612. The position selecting unit 1611 is a device which selects a position where the braille input through the braille input button 1211 is output in the braille output module 1611. For example, when the user selects the position selecting unit 1611 provided on a third braille cell among 14 braille cells and the user inputs braille, the braille is output in the third braille cell. The braille bump 1612 may protrude up and down in order to recognize the braille through the tactile sense of the user. Accordingly, when braille indicating “a” is input by the braille input button 1211, among braille bumps 1611 formed of eight bumps, only a braille bump located in 1 by 1 indicating braille corresponding to “a” protrudes.

As illustrated in FIG. 1, the braille input and output device 1000 may include an external apparatus connection display unit 1810 and a wired connecting unit 1830. The external apparatus connection display unit 1810 is a device to check whether the external apparatus 3000 is wirelessly connected thereto. Therefore, when the braille input and output device 1000 is wirelessly connected to the external apparatus 3000, the external apparatus connection display unit 1810 emits blue light and when the connection is in a standby state, blue light is turned off. In the meantime, a device which is wirelessly connected with the external apparatus 3000 will be described below. The wired connecting unit 1830 is a device which is wirely connected with the external apparatuses, like a USB. Therefore, the wired connecting unit 1830 may receive or transmit a signal to the external apparatus 3000 and an external power may be applied thereto.

As illustrated in FIG. 1, the braille input and output device 1000 may include a speaker 1621 and a voice output terminal 1622. The speaker 1621 is a device which outputs braille or a command which is input through the input key assembly 1210 as voice. The voice output terminal 1622 is a device which is connected to an external apparatus which outputs voice like an earphone and outputs voice information to the external apparatus connected to the voice output terminal 1622. The speaker 1621 and the voice output terminal 1622 are included in the voice output unit 1620. In the meantime, the braille input and output device 1000 may include a microphone 1220 which receives the voice.

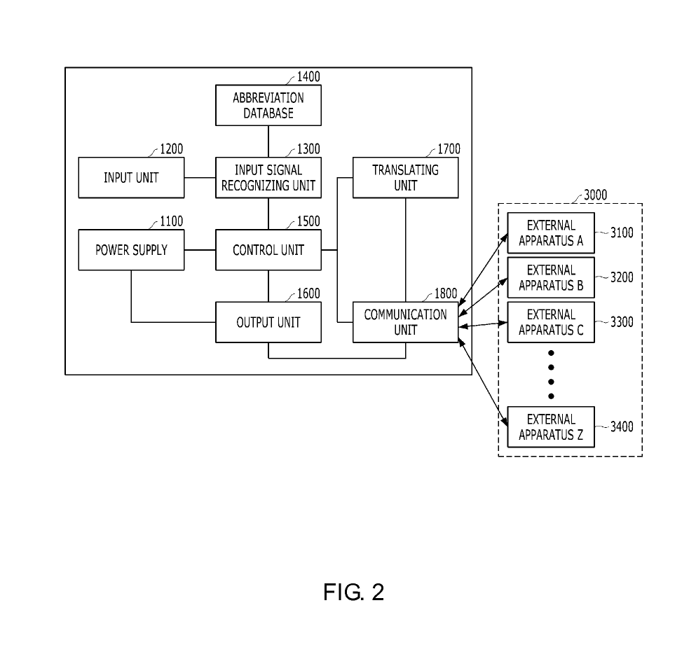

FIG. 2 is a diagram of a braille input and output device according to the present invention. As illustrated in FIG. 2, the braille input and output device 1000 may include a power supply 1100, an input unit 1200, an input signal recognizing unit 1300, an abbreviation database 1400, a control unit 1500, an output unit 1600, a translating unit 1700, and a communication unit 1800.

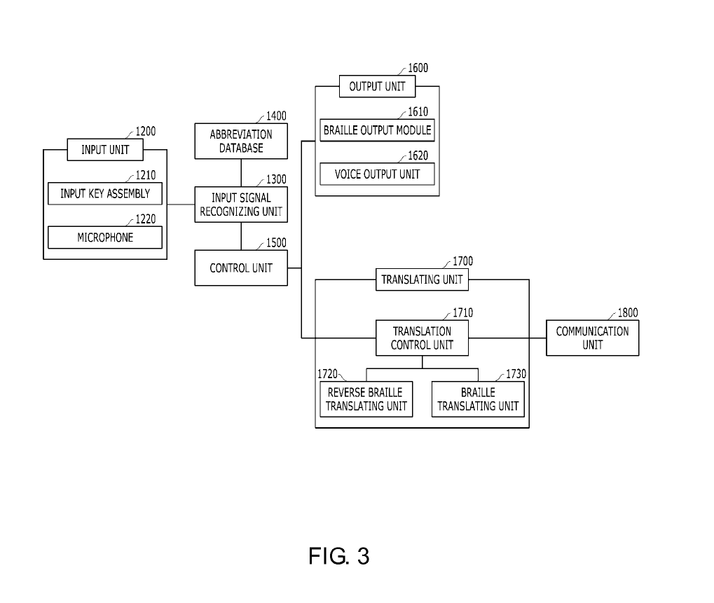

The power supply 1100 is a device which is applied with power from the outside and stores the power as electric energy. The power supply 1100 will be described below in detail with reference to FIG. 3.

The input unit 1200 is a device which generates an input signal through the input key assembly 1210 which is manipulated by the user.

The abbreviation database 1400 is a device in which information on at least one command which executes predetermined functions or abbreviations obtained by abbreviating words which are used as a language by a person who is not visually impaired is stored. For example, a word “about” is stored as an abbreviation of “ab” and a word “very” is stored as an abbreviation of “v”. The command and the abbreviation will be described in more detail with reference to FIGS. 3 to 5.

The input signal recognizing unit 1300 is a device which compares the signal input through the input key assembly 1210 with the at least one command or abbreviations which are stored in the abbreviation database 1400 to extract matching information. When a signal which is input through the input key assembly 1210 is “a braille input button 1” and “a braille input button 12”, the input signal recognizing unit 1300 extracts “a” corresponding to “the braille input button 1” and “b” corresponding to the “braille input button 12”. In the meantime, when the signal input through the input key assembly 1210 is “backspace-enter-U (U is a braille input button 136, the input signal recognizing unit 1300 extracts command information (wirely connecting the external apparatus) corresponding to “backspace-enter U”.

The control unit 1500 is a device which generates and transmits a command signal corresponding to the recognized information as the input signal recognizing unit 1300 recognizes the matching information. When the input signal recognizing unit 1300 recognizes information of “ab”, the control unit 1500 generates a command signal to output braille of “ab” and transmits the command signal to the output unit 1600. In the meantime, when the input signal recognizing unit 1300 recognizes information of “backspace-enter-U”, the control unit 1500 generates a command signal to wirely connect the external apparatus 300 and transmit the command signal to the communication unit 1800.

The output unit 1600 is a device which allows the user to tactilely or auditorily recognize the function or the abbreviation corresponding to the command signal.

The translating unit 1700 is a device which converts the abbreviation into a word which is used by a person who is not visually impaired. When the braille input through the input key assembly 1210 is “ab”, the translating unit 1700 converts the “ab” which is input as an abbreviation into “about” which is a word used by a person who is not visually impaired. The translating unit 1700 will be described below in detail with reference to FIG. 3.

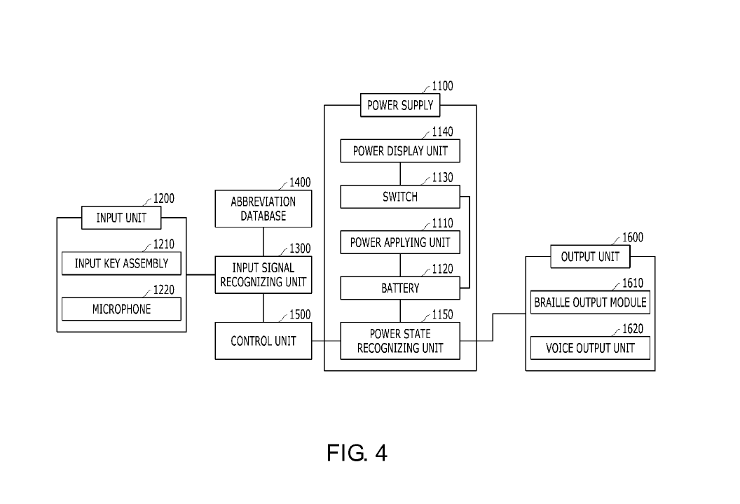

The communication unit 1800 is a device which allows the device 1000 to wirely or wirelessly communicate with the external apparatus 3000. The communication unit 1800 will be described below in detail with reference to FIG. 4.

FIG. 3 is a diagram illustrating a translating unit according to the present invention. Referring to FIG. 3, the translating unit 1700 includes a translation control unit 1710, a reverse braille translating unit 1720, and a braille translating unit 1730.

The translation control unit 1710 is a device which discerns the command signal transmitted through the control unit 1500 and generates a signal for translating the braille into a normal word or translating the normal word into the braille letter. The reverse braille translating unit 1720 is a device which converts the abbreviation into a word which is used by a person who is not visually impaired. The braille translating unit 1730 is a device which translates the word received from the external apparatus 3000 or used by another person who is not visually impaired into the abbreviation.

Braille to normal word translation (reverse braille translation) will be described by way of the following example.

When a signal of “1236” is input through the braille input button 1211 of the input key assembly 1210, the input signal recognizing unit 1300 compares with the input signal “1236” with one command or abbreviations stored in the abbreviation database 1400. The input signal recognizing unit 1300 recognizes that the signal “1236” is an alphabet “v”. Therefore, the control unit 1500 generates the command signal to output the alphabet “v” as braille and transmits the command signal to the translation control unit 1710. In accordance with the command signal transmitted to the translation control unit 1710, the reverse braille translation unit 1720 extracts the normal word “very” corresponding to the braille “v” from the abbreviation database 1400. The reverse braille translating unit 1720 transmits the extracted normal word “very” to the communication unit 1800. In the meantime, the braille output module 1610 embosses the braille “v” in accordance with the command signal which outputs “v” as braille to be recognized by the tactile sense of the person who is visually impaired. Further, the voice output unit 1620 outputs the word “very” corresponding to the abbreviation “v” as voice.

Normal word to braille translation (translation into braille) will be described by way of another example.

When the normal word “very” is input from the external apparatus 3000 through the communication unit 1800, the translation control unit 1710 transmits a translating signal which translates the normal word “very” into a braille abbreviation through the braille translating unit 1730. The braille translating unit 1730 extracts braille “v” corresponding to the normal word “very” from the abbreviation database 1400 in accordance with the received translating signal. The braille translating unit 1730 translates the extracted “v” into the braille. “v” which is translated through the braille translating unit 1730 is transmitted to the output unit 1600. The braille output module 1610 embosses the braille “v” to be recognized by the tactile sense of the person who is visually impaired. Further, the voice output unit 1620 outputs the voice “very”.

FIG. 4 is a diagram illustrating a power supply according to an exemplary embodiment of the present invention. The power supply 110 may include a power applying unit 1110, a battery 1200, a switch 1130, a power display unit 1140, and a power supply state recognizing unit 1150. The switch 1130 and the power display unit 1140 are the same as the description with reference to FIG. 1. The power applying unit 1110 is a device which is applied with power from the outside and may be considered to be similar to the wired connecting unit 1830 of the communication unit 8100. The battery 1120 is a device which stores the power applied through the power applying unit 1110 as electric energy. When the power supply state recognizing unit 1150 receives a command signal to check a state of the power supply 1100 from the control unit 1500, the power supply state recognizing unit 1150 checks an available remaining capacity of the battery 1120 and whether the power is being applied from the outside.

The power supply state recognizing unit 1150 will be described by way of the following example.

When a signal of the backspace button 1212, the enter button 1213, and the braille input button 1211 “1234” of the input key assembly 1210 is input, the input signal recognizing unit 1300 compares the input signal “backspace-enter-1234” with one command or abbreviations stored in the abbreviation database 1400. The input signal recognizing unit 1300 recognizes that the signal “backspace-enter-1234” is a signal to “check the state of the power supply 1100”. Therefore, the control unit 1500 generates a command signal to “check the state of the power supply 1100” and transmits the command signal to the power supply state recognizing unit 1150. The power supply state recognizing unit 1150 checks the remaining capacity of the battery 1120 and checks whether the power is being applied to the power applying unit 1110, in accordance with the received command signal. The power supply state recognizing unit 1150 transmits checked state information of the power supply 100 to the output unit 1600. The output unit 1600 embosses the state information of the power supply 1100 through the braille output module 1610 so as to be recognized by tactile sense of the person who is visually impaired. Further, the voice output unit 1620 outputs the state information of the power supply 1100 as voice. Therefore, when the state information of the power supply 1100 is “having remaining capacity of 20% and being charged”, the braille output module 1610 embosses “having remaining capacity of 20% and being charged” as braille and the voice output unit 1620 outputs “having remaining capacity of 20% and being charged” as voice.

Here, a command key which checks the state information of the power supply 100 is not limited to the key combination described above. Further, a method of embossing the state information of the power supply 1100 is not limited to the above-described example.

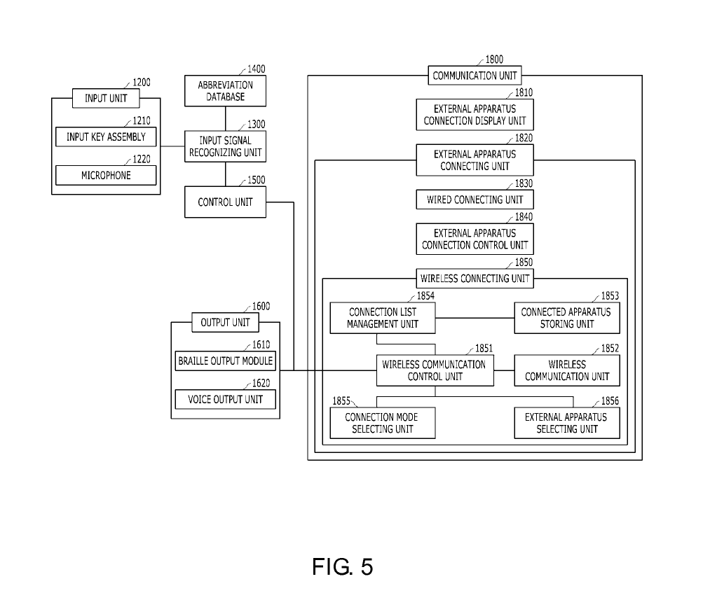

FIG. 5 is a diagram illustrating a communication unit 1800 according to the present invention. The communication unit 1800 may include an external apparatus connection display unit 1810 and an external apparatus connecting unit 1820. The external apparatus connection display unit 1810 the same as the description given with reference to FIG. 1.

As illustrated in FIG. 5, the external apparatus connecting unit 1820 may include a wired connecting unit 1830, an external apparatus connection control unit 1840, and a wireless connecting unit 1850. The wired connecting unit 1830 is a device which is wirely connected with the external apparatuses. When the wired connecting unit 1830 is a universal serial bus (USB), the information is transmitted and received to and from the external apparatus 300 through the USB and a voltage of +5V is applied to charge the battery 1120. The external apparatus connection control unit 1840 is a device which switches a communication method which wirely or wirelessly transmits/receives information. The external apparatus connection control unit 1840 switches the communication method into a wired method or a wireless method in accordance with the command signal transmitted from the control unit 1500. For example, when a command signal to wirelessly connect is received from the control unit 1500, the external apparatus connection control unit 1840 activates the wireless connecting unit 1850 to be wirelessly connected with the external apparatus 300 to communicate therewith. In the meantime, the communication method of the external apparatus connection control unit 1840 may be automatically changed. For example, when the external apparatus 3000 is connected to the wired connecting unit 1830, the external apparatus connection control unit 1840 switches the communication unit 1800 to be a wired method and when the external apparatus 300 is disconnected from the wired connecting unit 1830, the external apparatus connection control unit 1840 switches the communication unit 1800 to be a wireless method.

As illustrated in FIG. 5, the wireless connecting unit 1850 may include a wireless communication control unit 1851, a wireless communication unit 1852, a connected apparatus storing unit 1853, a connection list management unit 1854, a connection mode selecting unit 1855, and an external apparatus selecting unit 1856.

The wireless communication control unit 1851 is a device which controls the wireless connecting unit 1850 in accordance with the command signal transmitted from the control unit 1500.

The wireless communication unit 1852 is a device which wirelessly communicates with the external apparatus 3000. The wireless communication unit 1852 may be a module which may perform near field wireless communication, such as Bluetooth or ZigBee.

The connected apparatus storing unit 1853 is a device which stores apparatus information of the connected external apparatus 3000 when the device is wirelessly connected with the external apparatus 3000. When the communication is connected with the external apparatus 3000, the wireless communication unit 1852 receives information such as a name of a terminal, a communication type, or a serial number from the connected external apparatus 3000. Therefore, the connected apparatus storing unit 1852 stores received information of the name of the terminal, the communication type, and the serial number of the external apparatus 3000.

When a command signal to check a list of connected external apparatuses is transmitted from the control unit 1500, the connection list management unit 1854 extracts a predetermined number of apparatus information stored in the external apparatus storing unit 1853 for a predetermined period. Further, the connection list management unit 1854 transmits the extracted apparatus information to the output unit 1600.

The connection list management unit 1854 will be described by way of the following example.

When a signal of the backspace button 1212, the enter button 1213, and the braille input button 1211 “123” is input in the input key assembly 1210, the input signal recognizing unit 1300 compares the input signal “backspace-enter-123” with one command or abbreviations stored in the abbreviation database 1400. The input signal recognizing unit 1300 recognizes that the signal “backspace-enter-1234” is a signal to check a list of the external apparatus 300 which is connected to the wireless connecting unit 1850. Therefore, the control unit 1500 generates a command signal to “check a list of external apparatuses 300 which are connected to the wireless connecting unit 1850” and transmits the command signal to the wireless communication control unit 1851. The wireless communication control unit 1851 controls the connection list management unit 1854 to extract the predetermined number of apparatus information stored in the connected apparatus storing unit 1853 for a predetermined period, in accordance with the received command signal. When the predetermined number is ten and the period is six months, the connection list management unit 1854 extracts ten pieces of apparatus information of the external apparatus 3000 which is connected for six months. In the meantime, the apparatus information of the external apparatus 300 to be extracted is desirably time-sequentially listed. The connection list management unit 1854 transmits the extracted apparatus information to the output unit 1600. The braille output module 1610 embosses the apparatus information of the external apparatus 3000 to be recognized by the tactile sense of the person who is visually impaired. Further, the apparatus information of the external apparatus 3000 is output through the voice output unit 1620 as voice. By doing this, the user checks the list of the connected external apparatuses, so that the user may select an external apparatus 3000 to be connected.

When the command signal to change the communication mode is transmitted from the control unit 1500, the connection mode selecting unit 1855 selects one of a unidirectional mode and a bidirectional mode as the communication mode with the external apparatus 3000. Generally, Bluetooth uses a human interface device (HID) as the unidirectional mode and a serial port profile (SPP) as the bidirectional mode. The HID is a unidirectional mode in which data is generally transmitted and the SPP mode is a bidirectional communication mode in which the data is transmitted or received. Accordingly, when a specific external apparatus uses only the HID mode, the user changes a mode of the communication unit 1800 into the HID mode through the connection mode selecting unit 1855.

### [Example of Bidirectional Mode]

When the bidirectional mode is selected as the communication mode by the connection mode selecting unit 1855, the wireless communication unit 1852 transmits a word (normal word) which is used by person who is not visually impaired corresponding to the signal input through the input key assembly 1210 to the external apparatus 3000. For example, when a signal “1236” is input through the braille input button 1211 of the input key assembly 1210, the reverse braille translating unit 1720 recognizes the normal word “very” corresponding to the signal “1236”. The wireless communication unit 1852 transmits the recognized normal word “very” to the external apparatus 3000.

The wireless communication unit 1852 receives a word (normal word) and a braille signal which are used by the person who is not visually impaired from the external apparatus 3000. For example, when the wireless communication unit 1852 receives the normal word “very” from the external apparatus 3000, the braille translating unit 1730 recognizes the abbreviation “v” corresponding to the normal word “very” and transmits the braille signal of “1236” corresponding to “v” to the output unit 1600. The braille output module 1610 embosses 1236 dots in accordance with the transmitted braille signal of “1236” and the voice output unit 1620 outputs “very” as voice. As another example, when the wireless communication unit 1852 receives the braille signal of “1236” from the external apparatus 3000, the wireless communication unit 1852 transmits the braille signal of “1236” to the output unit 1600. The braille output module 1610 embosses 1236 dots in accordance with the received braille signal of “1236”. When the braille signal of “1236” is recognized as “very” through the reverse braille translating unit 1720, the voice output unit 1620 outputs “very” as voice.

### [Another Example of Bidirectional Mode]

When the communication mode is the bidirectional mode, the wireless communication unit 1852 may transmit only a signal which is input through the input key assembly 1210 to the external apparatus 3000. For example, when the signal of “1236” is input through the braille input button 1211 of the input key assembly 1210, the wireless communication unit 1852 transmits the signal of “1236” to the external apparatus 3000. The external apparatus 3000 recognizes the received signal of “1236” to translate the signal into the normal word ‘very”. The external apparatus 3000 transmits the recognized normal word “very” to the wireless communication unit 1852. Therefore, the braille output module 1610 embosses 1236 dots and the voice output unit 1620 outputs “very” as voice. In the above-described example, the external apparatus 3000 necessarily includes a translator (not illustrated) which translates the signal transmitted from the wireless communication unit 1852 into the normal word.

### [Unidirectional Mode]

When the unidirectional mode is selected as the communication mode by the connection mode selecting unit 1855, the wireless communication unit 1852 transmits a word (normal word) which is used by a person who is not visually impaired corresponding to the signal input through the input key assembly 1210 to the external apparatus 3000. In the case of the unidirectional mode, the braille input and output device 1000 does not receive the information from the external apparatus 3000.

The connection mode selecting unit 1855 will be described by way of the following example.

When a signal of the backspace button 1212, the enter button 1213, and the braille input button 1211 “234” is input in the input key assembly 1210, the input signal recognizing unit 1300 compares the input signal “backspace-enter-234” with one command or abbreviations stored in the abbreviation database 1400. The input signal recognizing unit 1300 recognizes that the signal “backspace-enter-234” is a signal to “change a communication mode of the wireless connecting unit 1850”.

Therefore, the control unit 1500 generates a command signal to change the communication mode of the wireless connecting unit 1850 to transmit the command signal to the wireless communication control unit 1851. The wireless communication control unit 1851 controls the connection mode selecting unit 1855 to change the communication mode into a unidirectional mode or a bidirectional mode in accordance with the received command signal. The connection mode selecting unit 1855 transmits the changed mode information to the output unit 1600. The braille output module 1610 embosses the changed mode information to be recognized by the tactile sense of a person who is visually impaired. Further, the voice output unit 1620 outputs the changed mode information as voice.

The external apparatus selecting unit 1856 is a device which wirelessly connects a predetermined number of external apparatuses usable in a specific mode which are selected by the connection mode selecting unit 1855. The wireless connecting unit 1850 may be wirelessly connected to a predetermined number of external apparatuses and circularly communicates with a plurality of connected external apparatuses. In the meantime, a command for circular communication is stored in the abbreviation database 1400. When the connection mode selecting unit 1855 is set to be a bidirectional mode (SPP mode), the external apparatus selecting unit 1856 is wirelessly connected with the external apparatus 300 which supports the bidirectional mode. When the connection mode selecting unit 1855 is set to be a combo mode which supports both the unidirectional mode and the bidirectional mode, the external apparatus selecting unit 1856 is connected in both the unidirectional mode and the bidirectional mode.

What is claimed is:

1. A braille input and output device, comprising:
an input key assembly which is manipulated by a user;
an abbreviation database in which information on abbreviations obtained by abbreviating words which is used as at least one command which executes predetermined functions or as languages by a person who is not visually impaired is stored;
an input signal recognizing unit which compares the signal input through the input key assembly with the at least one command or abbreviations which are stored in the abbreviation database to extract matching information;
a control unit which generates and transmits a command signal corresponding to the recognized information as the input signal recognizing unit recognizes the matching information;
a braille output module which embosses the function or the abbreviation corresponding to the command signal as braille to be recognized by a tactile sense; and
a translating unit which converts the abbreviation into a word which is used by the person who is not visually impaired.

2. The braille input and output device of claim 1, further comprising:
a communication unit which wirely or wirelessly communicates with the external apparatus.

3. The braille input and output device of claim 2, wherein the translating unit includes a reverse braille translating unit which converts the abbreviation into a word used by the person who is not visually impaired and a braille translating unit which translates the word which is received from the external apparatus or used by another person who is not visually impaired into the abbreviation.

4. The braille input and output device of claim 1, further comprising:
a voice output unit which outputs information corresponding to the command signal as voice.

5. The braille input and output device of claim 2, wherein the communication unit further includes:
a connected apparatus storing unit which stores apparatus information of the connected external apparatus when the device is wirelessly connected with the external apparatus;
a wireless communication control unit which receives a command signal to check a connection list from the control unit; and
a connection list management unit which extracts a predetermined number of apparatus information stored in the external apparatus storing unit for a predetermined period in accordance with the command signal to check the connection list to transmit the extracted apparatus information to the braille output module.

6. The braille input and output device of claim 5, wherein the wireless communication control unit further receives a command signal to change the wireless communication mode from the control unit and
the communication unit further includes: a connection mode selecting unit which selects any one of a unidirectional mode and a bidirectional mode as a communication mode with the external apparatus in accordance with a command signal to change the wireless communication mode; and
a connecting apparatus selecting unit which wirelessly connects a predetermined number of external apparatuses used in a specific mode, selected by the external apparatus selecting unit.

7. The braille input and output device of claim 6, wherein the communication unit further includes:
a wireless communication unit which transmits a word used by the person who is not visually impaired corresponding to the signal input through the input key assembly to the external apparatus and receives a word and a braille signal which is used by another person who is not visually impaired from the external apparatus when the communication mode is a bidirectional mode.

8. The braille input and output device of claim 6, wherein the communication unit further includes:
a wireless communication unit which transmits a word used by the person who is not visually impaired corresponding to the signal input through the input key assembly to the external apparatus when the communication mode is a unidirectional mode.
